(19) United States
(12) Patent Application Publication
(10) Pub. No.: US 2026/0313387 A1
(43) Pub. Date: Oct. 8, 2026

(54) METHOD FOR SUPPORTING SPATIAL COMPUTING FUNCTIONS IN IMS-BASED AUGMENTED REALITY CALLS WITH DATA CHANNELS

(71) Applicant: InterDigital VC Holdings, Inc., Wilmington, DE (US)

(72) Inventors: Ahmed Hamza, Coquitlam (CA); Srinivas Gudumasu, Montreal (CA)

(73) Assignee: InterDigital VC Holdings, Inc., Wilmington, DE (US)

(21) Appl. No.: 19/172,589

(22) Filed: Apr. 7, 2025

(51) Int. Cl. H04W 16/28; H04L 65/1016; H04W 8/22; H04W 76/10

(52) U.S. Cl. CPC H04W 16/28; H04L 65/1016; H04W 8/22; H04W 76/10

(57) ABSTRACT

This present system, methods and device relate to the support for execution of spatial computing function in IP multimedia subsystem (IMS)-based augmented reality (AR) calls with data channel support. This enables the WTRU to offload, based on its capabilities and conditions, some spatial computing function to the media function (MF) in the IMS architecture.

### BACKGROUND

Generally, any spatial computing processing is processed locally on WTRUs that are powerful enough to handle such operations. However, many devices may not be able to support some or all spatial computing functions. In many scenarios, these functions require more powerful processing resources that may be provisioned in the network. However, there is no well-defined architecture to enable such spatial computing services in the network in a standardized fashion. Specifically, there is no support for such a service in IMS-based architectures deployed by mobile network operators.

### SUMMARY

This present system, methods and device relate to the support for execution of spatial computing function in IP multimedia subsystem (IMS)-based augmented reality (AR) calls with data channel support. This enables the WTRU to offload, based on its capabilities and conditions, some spatial computing function to the media function (MF) in the IMS architecture.

A method of executing a spatial computing function in IP multimedia subsystem (IMS)-based augmented reality (AR) calls with data channel (DC) support is described. The method includes performing spatial computing (SC) session setup and negotiation, establishing an application session configured based on the performed SC setup and negotiation and running an invoked SC function. The performing SC session setup and negotiation may include receiving an application DC request from a wireless transmit receive unit (WTRU), creating a configuration at least including originating and terminating side DC media information, configuring DC control instructions, creating a spatial computing session request based on the created configuration and configured instructions, allocating media resources based on the created spatial computing session request and establishing a session based on the allocated media resources. The receiving an application DC request from the WTRU may be via the IP multimedia subsystem (IMS). The creating a configuration at least including originating and terminating side DC media information may be via the DC signaling function (DCSF) of the IMS. The creating a spatial computing session request based on the created configuration and configured instructions may be via the DCSF. The allocating media resources based on the created spatial computing session request may be via media function (MF) of the IMS. The establishing an application session configured based on the performed SC setup and negotiation may include determining application source data, exchanging configuration information, and configuring SC function. The determining application source data may be via the MF of the IMS and the WTRU. The exchanging configuration information may be between the MF of the IMS and the WTRU.

A system for executing a spatial computing function in IP multimedia subsystem (IMS)-based augmented reality (AR) calls with data channel (DC) support is described. The system includes an IMS, the IMS including an IMS application server (AS), a DC signaling function (DCSF) and a media function (MF) including a spatial computing (SC) function. The IMS may perform spatial computing (SC) session setup and negotiation, establish an application session configured based on the performed SC setup and negotiation and run an invoked SC function. The performing SC session setup and negotiation includes the IMS receiving an application DC request from a wireless transmit receive unit (WTRU), the IMS creating a configuration at least including originating and terminating side DC media information, the IMS configuring DC control instructions, the IMS creating a spatial computing session request based on the created configuration and configured instructions, the IMS allocating media resources based on the created spatial computing session request and the IMS establishing a session based on the allocated media resources. The creating a configuration at least including originating and terminating side DC media information may be via the DC signaling function (DCSF) of the IMS. The creating a spatial computing session request based on the created configuration and configured instructions may be via the DCSF. The allocating media resources based on the created spatial computing session request may be via media function (MF) of the IMS. The establishing an application session configured based on the performed SC setup and negotiation includes the IMS determining application source data, the IMS exchanging configuration information and the IMS configuring SC function. The determining application source data may be via the MF of the IMS and the WTRU. The exchanging configuration information may be between the MF of the IMS and the WTRU. The system may further include the IMS running the SC function. The running the SC function may occurs in the MF of the IMS. The MF may further include a SC function element for running the SC function.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an architecture of IMS supporting data channel (DC) usage with a media function (MF);

FIG. 3 illustrates an exemplary IMS DC Architecture to support AR communication;

FIG. 4 illustrates an exemplary IMS DC architecture configured to support spatial computing; and

FIG. 5 illustrates a method for spatial computing session establishment and operation.

### DETAILED DESCRIPTION

This present system, methods and device relate to the support for execution of spatial computing function in IP multimedia subsystem (IMS)-based augmented reality (AR) calls with data channel support. This enables the WTRU to offload, based on its capabilities and conditions, some spatial computing function to the media function (MF) in the IMS architecture.

A method of executing a spatial computing function in IP multimedia subsystem (IMS)-based augmented reality (AR) calls with data channel (DC) support is described. The method includes performing spatial computing (SC) session setup and negotiation, establishing an application session configured based on the performed SC setup and negotiation and running an invoked SC function. The performing SC session setup and negotiation may include receiving an application DC request from a wireless transmit receive unit (WTRU), creating a configuration at least including originating and terminating side DC media information, configuring DC control instructions, creating a spatial computing session request based on the created configuration and configured instructions, allocating media resources based on the created spatial computing session request and establishing a session based on the allocated media resources. The receiving an application DC request from the WTRU may be via the IP multimedia subsystem (IMS). The creating a configuration at least including originating and terminating side DC media information may be via the DC signaling function (DCSF) of the IMS. The creating a spatial computing session request based on the created configuration and configured instructions may be via the DCSF. The allocating media resources based on the created spatial computing session request may be via media function (MF) of the IMS. The establishing an application session configured based on the performed SC setup and negotiation may include determining application source data, exchanging configuration information, and configuring SC function. The determining application source data may be via the MF of the IMS and the WTRU. The exchanging configuration information may be between the MF of the IMS and the WTRU.

A system for executing a spatial computing function in IP multimedia subsystem (IMS)-based augmented reality (AR) calls with data channel (DC) support is described. The system includes an IMS, the IMS including an IMS application server (AS), a DC signaling function (DCSF) and a media function (MF) including a spatial computing (SC) function. The IMS may perform spatial computing (SC) session setup and negotiation, establish an application session configured based on the performed SC setup and negotiation and run an invoked SC function. The performing SC session setup and negotiation includes the IMS receiving an application DC request from a wireless transmit receive unit (WTRU), the IMS creating a configuration at least including originating and terminating side DC media information, the IMS configuring DC control instructions, the IMS creating a spatial computing session request based on the created configuration and configured instructions, the IMS allocating media resources based on the created spatial computing session request and the IMS establishing a session based on the allocated media resources. The creating a configuration at least including originating and terminating side DC media information may be via the DC signaling function (DCSF) of the IMS. The creating a spatial computing session request based on the created configuration and configured instructions may be via the DCSF. The allocating media resources based on the created spatial computing session request may be via media function (MF) of the IMS. The establishing an application session configured based on the performed SC setup and negotiation includes the IMS determining application source data, the IMS exchanging configuration information and the IMS configuring SC function. The determining application source data may be via the MF of the IMS and the WTRU. The exchanging configuration information may be between the MF of the IMS and the WTRU. The system may further include the IMS running the SC function. The running the SC function may occurs in the MF of the IMS. The MF may further include a SC function element for running the SC function.

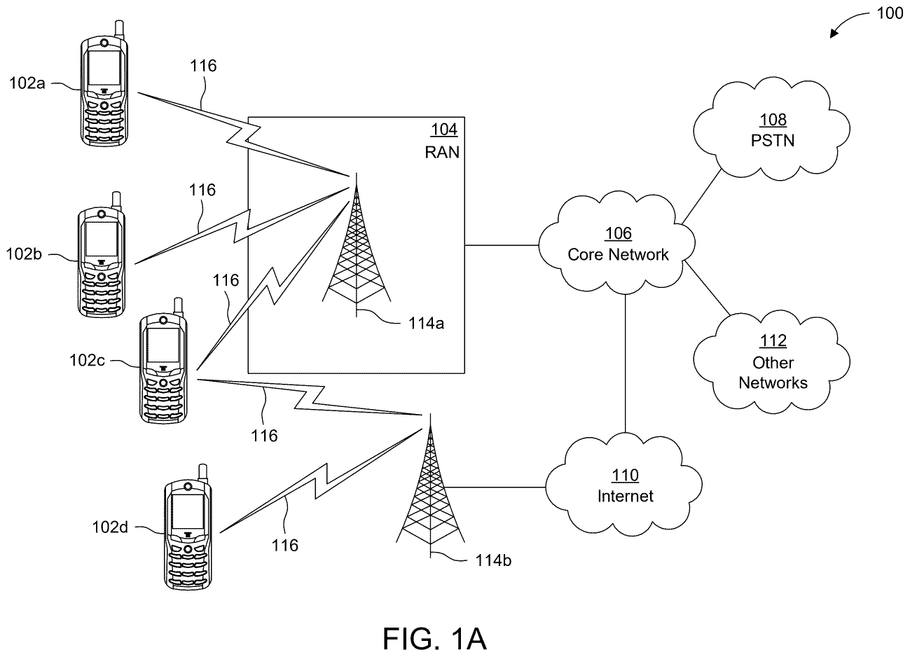

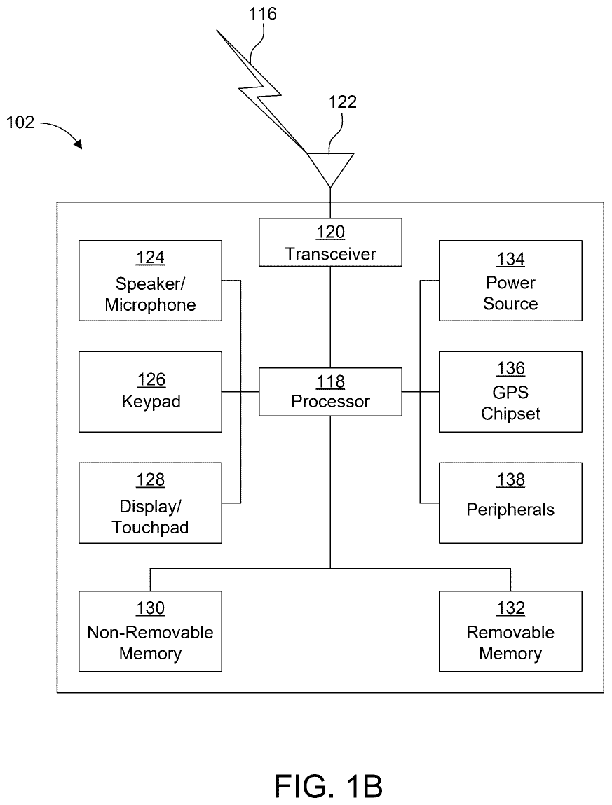

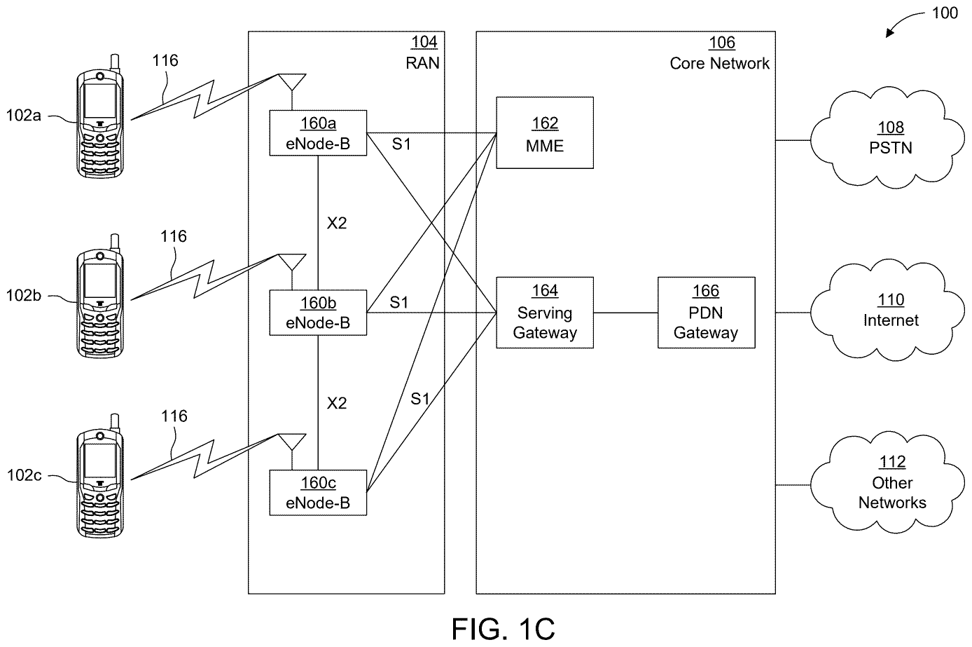

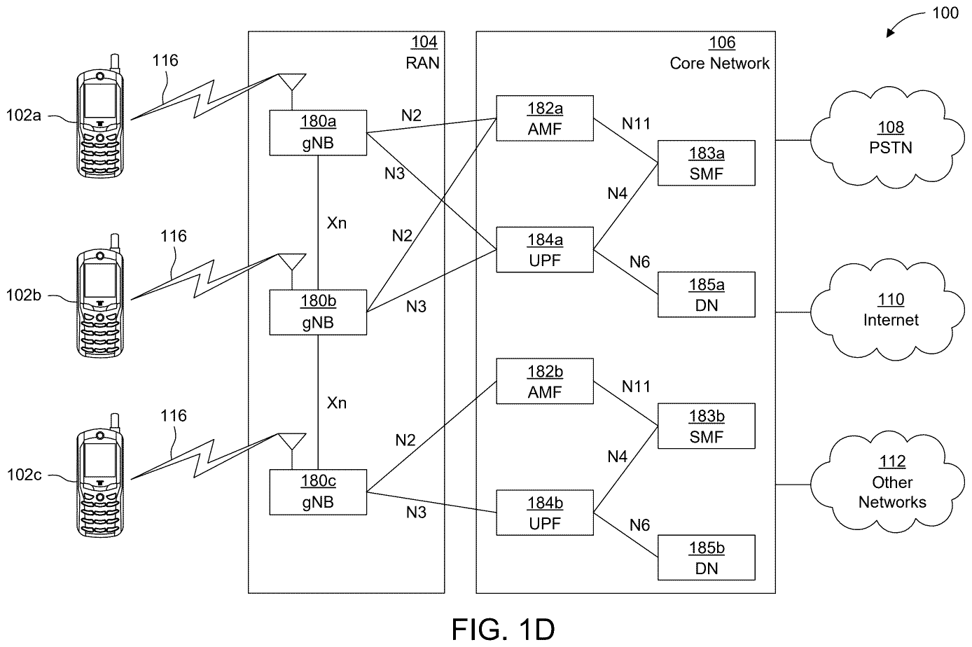

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Data Channels are described IP multimedia subsystems (IMS). The IMS stage-2 service description is specified. The IMS architecture enhancements support data channel services, which supports separation of the signaling function and the media function (MF) supporting data channel services.

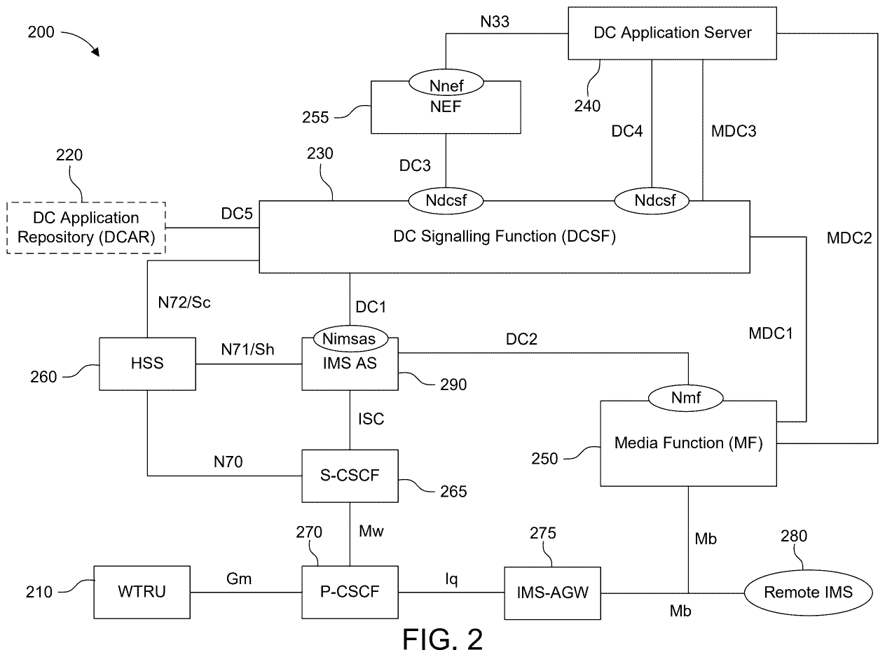

FIG. 2 illustrates an architecture 200 of IMS supporting data channel (DC) usage with a media function 250 (MF). FIG. 2 illustrates the main network functions (components) of the general architecture of IMS with data channel support and the main reference points between these components. Network functions in architecture 200 include a DC application server 240 (DCAS), DC signaling function 230 (DCSF), media function 250 (MF), DC application repository 220 (DCAR), and IMS application server 290 (IMS AS).

DCAS 240 acts as the endpoint for application data channels. DCAS 240 communicates with DCSF 230 for resource control and traffic forwarding and supports the interaction with multiple WTRUs for simultaneous data channel applications.

DCSF 230 manages the signaling control for data channels. DCSF 230 implements data channel control and manages resources for both bootstrap and application data channels. DCSF 230 also manages the download and configuration of data channel applications from DCAR 220. DCSF 2320 receives event reports from IMS AS 290 and decides whether data channel service is permitted during the IMS session. DCSF 230 manages bootstrap data channel and (if applicable) application data channel resources at MF 250 via IMS AS 290. DCSF 230 manages interworking between application data channel media and audio/video media when applied and instructs to MF 250 via IMS AS 290. DCSF 230 supports HTTP web server functionality to download data channel applications (bootstrapping) via MF 250 to WTRU 210 based on WTRU subscription. DCSF 230 downloads data channel applications from DCAR 220. DCSF 230 interacts with NEF 255 for data channel capability exposure via DC3. DCSF 230 interacts with the DC AS 240 for DC resource control via DC4/DC3/N33 and for traffic forwarding via MDC3. DCSF 230 interacts with HSS 260 for retrieving and storing DCSF 230 service specific data via N72/Sc.

MF 250 manages media resources and forwards data channel traffic. MF 250 terminates the bootstrap data channel from the WTRU and forwards HTTP traffic to DCSF 230. MF 250 provides the media resources to anchor application data channels and relays the traffic between the WTRUs. MF 250 may terminate the application data channel by acting as an HTTP proxy or it may simply relay traffic by acting as UDP proxy. MF 250 manages the data channel media resources (bootstrap and application data channel resources, if applicable) under the control of the IMS AS 290. MF 250 terminates the bootstrap data channel from WTRU 210 and forwards HTTP traffic between WTRU 210 and DCSF 230 via MDC1. MF 250 may anchor the application data channel in P2P scenarios, if required and forward application data traffic from/to WTRUs. MF 250 may relay traffic on the A2P/P2A application data channels between WTRU 210 DC AS 240 via MDC2. MF 250 may handle transcoding of data channel media following the media instructions from DCSF 230.

DCAR 220 stores and manages verified data channel applications. These can then be downloaded by the WTRU through DCSF 230 and MF 250.

IMS AS 290 is enhanced to support data channel functionalities and manage interactions between the different entities.

IMS AS 290 interacts with DCSF 230 via DC1 for event notifications. IMS AS 290 interacts with NEF 255 for event subscription and notification. IMS AS 290 receives the data channel control instructions from DCSF 230 and accordingly interacts with MF 250 via DC2 for data channel media resource management. IMS AS 290 interacts with HSS 260 for retrieving and storing DC enhanced IMS AS 290 service specific data via N71/Sh. IMS AS 290 receives data channel control request from NEF 255/DC AS 240 for establishment, update or release of bootstrap data channel and/or application data channel. IMS AS 290 may register in NRF with respect to the events it supports. IMS AS 290 interacts with HSS 260 to register its NF instance for event subscription.

NEF 255 supports exposure of IMS DC events and IMS DC capability.

HSS 260 stores IMS data channel subscription data as transparent data. HSS 260 interacts with DCSF 230 during service data retrieval by DCSF 230 via N72/Sc. HSS 260 interacts with IMS AS 290 during service data retrieval by IMS AS 290 via N71/Sh. HSS 260 interacts with IMS AS 290 to subscribe to event notifications on behalf of other NF, e.g. NEF 255 or DC AS 240. HSS 260 supports IMS DC event subscription.

Serving (S)-CSCF 265 performs the session control services for WTRU 210. S-CSCF 265 maintains a session state as needed by the network operator for support of the services. Within an operator's network, different S-CSCFs may have different functionalities.

Proxy (P)-CSCF 270 provides a contact point within the IM CN subsystem. Its address is discovered by WTRUs using the mechanism described in the clause “Procedures related to Local CSCF Discovery”. P-CSCF 270 behaves like a Proxy by accepting requests and servicing the requests them internally or forwards them on. P-CSCF 270 may behave as a User Agent. P-CSCF 270 in the role of an AF may interact with the Policy and Charging Architecture. P-CSCF 270 may interact over the Rx interface with the Policy and Charging Architecture. P-CSCF 270 may interact over the Rx interface or over the N5 interface.

IMS-AGW 275 may support end-to-end rate adaptation between WTRU 210 and the remote entity.

Remote IMS 280 may be a peer WTRU, subscriber or third party.

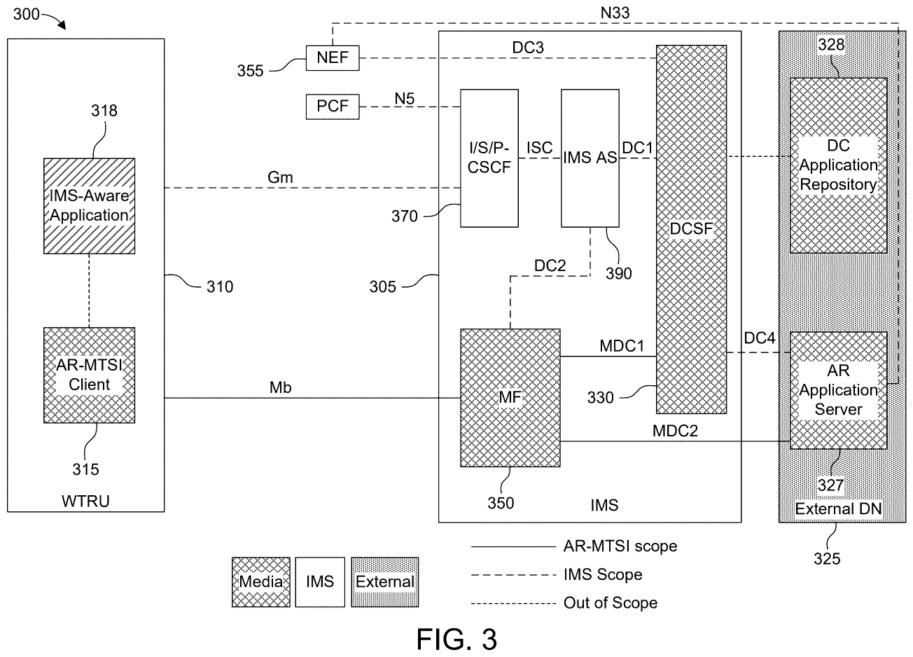

Architecture 200 of FIG. 2 provides an IMS-based conversational AR services and in conjunction with FIG. 2, an architecture 300 of FIG. 3 includes a generalized end-to-end architecture to support AR communication over IMS DC.

FIG. 3 illustrates an exemplary IMS DC architecture 300 to support AR communication. Architecture 300 illustrates the main network functions, components and reference points to enable AR communication with data channel (DC) support. As described with respect to FIG. 2, the various entities described therein may perform their respective function with respect to architecture 300 of FIG. 3. This may include at least NEF 355 and I/S/P-CSCF 370, for example. Architecture 300 may support AR communication between WTRU 310 and IMS 305 and external DN 325.

IMS aware application 318 is an application that interacts with MTSI clients, including DC MTSI clients, through well-defined interfaces to access IMS-based services.

AR application server 327 (AR AS) is responsible for AR service control related to AR communication, including AR session media control and AR media capability negotiation with WTRU 310.

DCSF 330 receives event reports from IMS AS 390 and decides whether AR communication service is allowed to be provided during the IMS session. DCSF 330 interacts with the AR AS 327 for DC resource control.

MF 350 supports AR conversational service by providing transcoding for terminals with limited capabilities. MF 350 may collect spatial and media descriptions from WTRUs and create scene descriptions for symmetrical AR call experiences. MF 350 may provide remote rendering for AR-MTSI clients 315 in terminals with limited capabilities based on rendering negotiation. For remote rendering the AR-MTSI client 315 provides AR metadata.

IMS AS 390 receives the media control instructions from DCSF 330 and accordingly interacts with WTRU 310 for connecting audio/video media termination of WTRU 310 to MF 350 and interacts with MF 350 for data channel media resource management for AR media processing.

XR spatial computing encompasses a set of functions which process sensor data to generate information about the world 3D space surrounding the AR user. These include functions such as re-localization (establishing the position of users and objects within that space), anchoring, 3D Model construction, segmentation and labeling (semantic perception) and light extraction, are achieved through a combination of advanced sensors, cameras, and algorithms that enable devices to understand and interact with the three-dimensional space around them.

The output of spatial computing is spatial mapping information that is organized in a data structure called the XR Spatial Description for storing and exchanging the information. Some spatial computing functions may also take an XR spatial description and may result in updates to the XR spatial description. Spatial computing functions typically include data exchange and require a network architecture.

An AR device may provide sensor data to the spatial computing function to create or update the spatial mapping information. The device may also access the spatial computing function to retrieve different spatial mapping information depending on the needs of the XR application. The spatial computing functions can run locally on the AR device or can be executed remotely on the cloud or on the edge in a spatial computing server accessed through dedicated interfaces.

A number of spatial computing functions have been defined in the art. The potential formats for the inputs to these computing functions and outputs from these computing functions, and a possible mapping to a generalized media delivery architecture are understood. As set forth herein a mapping to the IMS architecture for IMS-based spatial computing is provided. Supporting MNO managed spatial computing services in the IMS architecture is described and setup and configure the service for real-time AR communication session in 5G/6G networks.

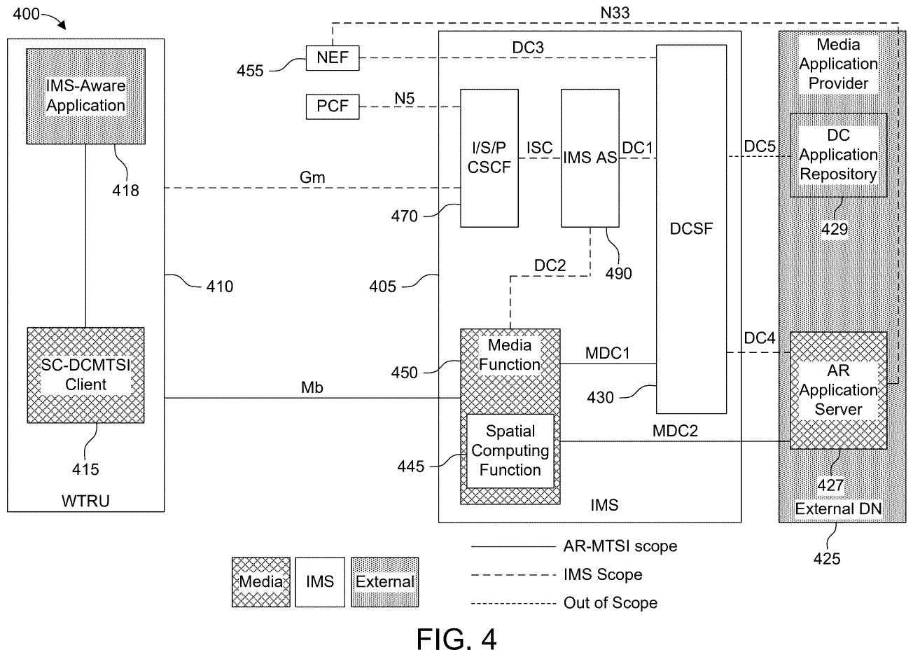

The generalized IMS DC architecture to support spatial computing is shown in the following figure. FIG. 4 illustrates an exemplary IMS DC architecture 400 configured to support spatial computing. As described with respect to FIGS. 2 and 3, the various entities described therein may perform their respective function with respect to architecture 400 of FIG. 4. This may include at least NEF 455, IMS aware application 418, DC application repository 429 and I/S/P-CSCF 470, for example. Architecture 400 may support spatial computing between WTRU 410 and IMS 405 and external DN 425. FIG. 4 and architecture 400 illustrates the main components and extensions to the IMS DC architecture for AR communication (architecture 300 of FIG. 3) to support the use of in-network spatial computing functions and the main relevant reference points in the IMS DC architecture.

Spatial computing over IMS may be enabled by using reference points described below.

SC DCMTSI client 415 and MF 450 may be coupled with connection Mb. Mb provides a reference point to enable spatial computing between WTRU 410 and MF 450.

WTRU 410 and IMS AS 490 may be coupled with connection Gm. Gm provides a reference point to support communication between WTRU 410 and IMS 405.

MF 450 and DCSF 430 may be coupled with connection MDC1. MDC1 provides a reference point for transport of data channel media between data channel MF 450 and DCSF 430. MF 450 terminates the bootstrap data channel from WTRU 410 via Mb and forwards HTTP traffic between WTRU 410 and DCSF 430 via MDC1.

MF 450 and DC AS 427 may be coupled with connection MDC2. MDC2 provides a reference point for transport of data channel media between data channel MF 450 and DC AS 427, for spatial computing functions between application server to MF 450. MF 450 relay traffic on application-to-person (A2P)/person-to-application (P2A) application data channels between WTRU 410 and the DC AS 427 via MDC2. P2A is a data channel setup procedure where a person (or user) initiates a connection to an application, as opposed to a direct person-to-person connection (P2P) or an application-to-person connection (A2P).

I/S/P CSCF 470 and DCSF 430 may be coupled with connection DC1. DC1 provides a reference point between DCSF 430 and IMS AS 490.

MF 450 and I/S/P CSCF 470 may be coupled with connection DC2. DC2 provides a reference point between IMS AS 490 and MF 450, for spatial computing related data channel media resource management.

NEF 455 and DCSF 430 may be coupled with connection DC3. DC3 provides a reference point between DCSF 430 and NEF 455.

DCSF 430 and DC AS 427 may be coupled with connection DC4. DC4 provides a reference point between DCSF 430 and DC AS 427.

NEF 455 and DC AS 427 may be coupled with connection N33. N33 provides a reference point between NEF 455 and DC AS 427 providing network exposure to enable spatial computing related applications.

SC-DCMTSI client 415 a spatial computing DCMTSI client. SC-DCMTSI client 415 is a DCMTSI client in WTRU 410, which supports spatial computing. SC-DCMTSI client 415 may be responsible for acquiring media spatial computing capabilities and interacting with IMS functions during a spatial computing session. SC-DCMTSI client 415 may be responsible for the signaling with DCSF 430 via IMS AS 490 to set up a spatial computing session and for negotiating with MF 450 and DC AS 427 about the parameters of the spatial computing session. SC-DCMTSI client 415 may perform, or is capable of performing, initiating a request of spatial computing session establishment, establishing spatial a computing session, including signaling with DCSF 430 via IMS AS 490 to set up the data channel, and MF 450 and DC AS 427 to set up the spatial computing, operating the rendering loop on WTRU 410, updating the rendering loop according to the network parameters and media capabilities with IMS functionalities, and stopping the spatial computing session.

MF 450 may be responsible for interacting with SC-DCMTSI client 415 and DC AS 427 during the spatial computing process, monitoring resource usage, managing and running the spatial computing process, etc. MF 450 may incorporate a spatial computing function 445 (SCF) which is capable of running a number of spatial computing tasks, such as the spatial computing functions on behalf of WTRU 410. MF 250 may perform, or is capable of performing, negotiating and interacting with SC-DCMTSI client 415 (via IMS AS 490) and DC AS 427 to establish the spatial computing session, running spatial computing processes, including, receiving meta-data from the SC-DCMTSI client 415, and forwarding requests to DC AS 427 based on the spatial computing logic, exposing the capabilities, capacity, and media processing and spatial computing capabilities of MF 450 to DC AS 427, and stopping/pausing/resuming the spatial computing session according to the requests from WTRU 410.

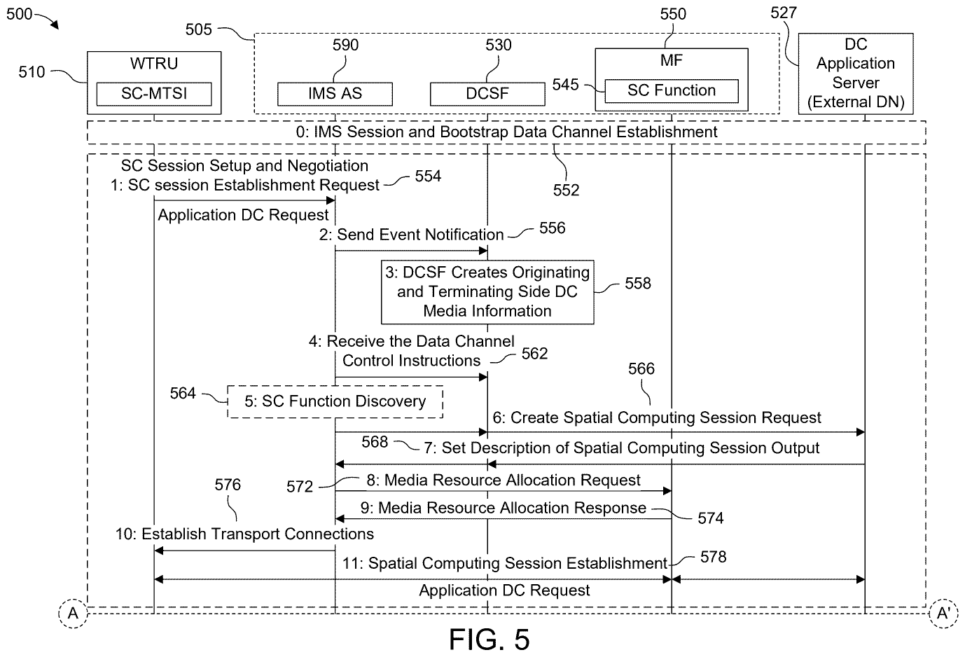

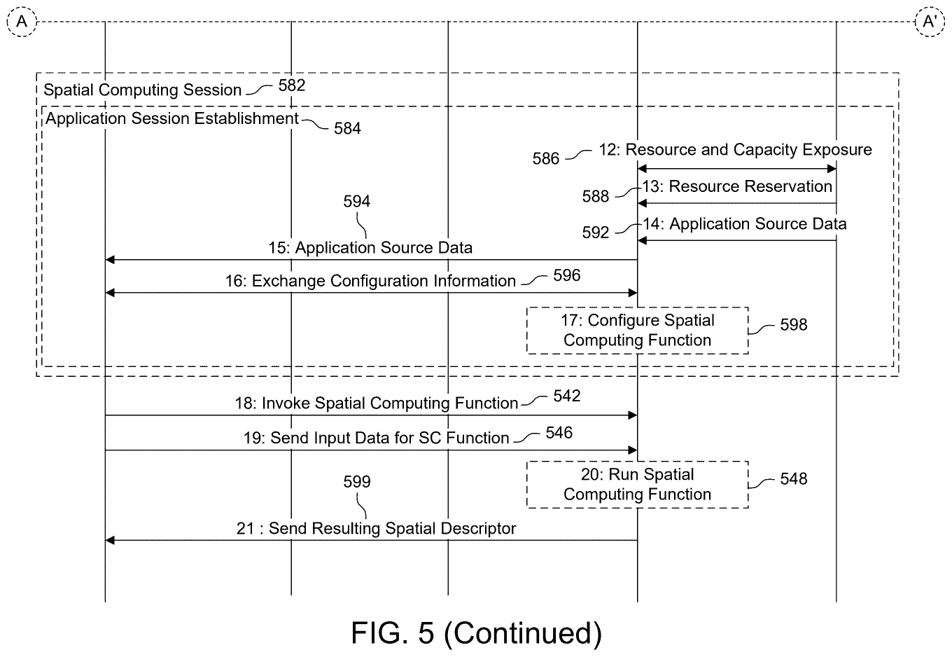

FIG. 5 illustrates a method 500 for spatial computing session establishment and operation. Method 500 includes a WTRU 510 with a SC-MTSI, an IMS 505 including an IMS AS 590, a DCSF 530, and a MF 550 with a SC function 545, and a DC application server (DC AS) 527 that may be an external DN.

Method 500 generally includes, at 552, initiating an IMS session and bootstrap data channel establishment and, at 582, establishing a spatial computing session. Method 500 includes, at 552, WTRU 510 initiating an IMS session, including bootstrap data channel establishment, with the originating Media Function. At 554, method 500 includes WTRU 510 sending a request to IMS AS 590 to establish an application data channel for a spatial computing session. WTRU 510 can initiate a request for spatial computing session establishment if WTRU 510 spatial computing capabilities cannot meet the related compute and rendering requirements. WTRU 510 calculates which operations and spatial computing functions WTRU 510 can perform based on its status and decides which functions to be performed in WTRU 510 and which be run in the IMS network.

At 556, method 500 includes IMS AS 290 sending DCSF 530 the event notifications including spatial computing related information. At 558, method 500 includes DCSF 230 receiving event notifications from IMS AS 290 and processes the session establishment request based on the information in the notification (i.e., associated spatial computing related information). DCSF 230 manages (if applicable) application data channel resources at MF 550 which meet the spatial computing request, to instruct IMS AS 590 to terminate the media flow of WTRU 510 to SC Function 545.

At 562 and 564, method 500 includes IMS AS 590 receiving the data channel control instructions from DCSF 230 and accordingly interacts with MF 550 via DC2. At 566, method 500 includes IMS AS 590 sending a spatial computing session establishment request to DC AS 527 via DCSF 230. The request may include the spatial computing functions to be run in the IMS network. At 568, method 500 includes DC AS 527 sending a description of the spatial computing output to IMS AS 590 via DCSF 530. The description of the spatial computing output is a spatial descriptor that may be negotiated. At 528, method 500 includes IMS AS 590 sending the media resource allocation request to MF 550, to reserve spatial computing resources for WTRU 510. At 574, when the resources are allocated successfully, method 500 includes MF 550 returning a successful response to IMS AS 590. At 576, method 500 includes IMS AS 590 returning a successful response to WTRU 510. At 578, method 500 includes establishing a successful spatial computing session between WTRU 510 and MF 550 through the application data channel. Spatial computing session 582 includes application session establishment at 584. At 586, method 500 includes MF 450 exposing the current capabilities and resources of MF 450 to DC AS 527. The information exposed may be the hardware and software stack and the resources currently available at MF 450, including the supported spatial computing functions. At 588, method 500 includes DC AS 527 selecting resources at MF 550 and requests MF 550 to reserve these resources. At 592, method 500 includes DC AS 527 transferring application source data, for example scripts and scene graph, and graphical assets to MF 550. At 594, method 500 includes WTRU 510 relevant application source data being sent to WTRU 510. At 596, method 500 includes WTRU 510 and MF 550 negotiating the spatial computing session configuration. At 598, method 500 includes MF 550 configuring which spatial computing functions are to be used in the session.

At 542, method 500 includes WTRU 510 sending a request to invoke a spatial computing function. At 546, method 500 includes WTRU 510 uploading any data required as input to the desired spatial computing function. This data could be for example sensor data collected by WTRU 510. At 548, method 500 includes MF 250 running the spatial computing function and, at 599 returns the resulting spatial descriptor to WTRU 510.

All WTRUs that support IMS data channels are expected to establish a bootstrap data channel as described. This bootstrap channel is used for initial data channel signaling and for retrieving a list of available data channel applications from DCSF 530. WTRU 510 uses HTTP over this bootstrap channel to request the application catalog from DCAR 220 through DCSF 530 and MF 550.

DCAR 220 replies with a catalog that includes both standard web applications and spatial computing functions. SC functions may be annotated with clear metadata so that WTRU 510 may distinctly present them to the user. WTRU 510 establishes a separate application data channel to handle configuration messages. This application data channel is set up according to standard IMS data channel negotiation procedures, ensuring it is separate from the bootstrap channel. The protocol details and message formats used on this application data channel for spatial computing configuration can be proprietary, but the underlying data channel transport is expected to comply with IMS data channel security, integrity, and resource control requirements.

MF 550 may register capabilities such as spatial computing functions capabilities, graphics and computing capabilities, available memory, etc., to IMS AS 590. When WTRU 510 establishes a spatial computing session to IMS AS 590 requesting specific spatial computing functionalities to be performed in the IMS network, IMS AS 590 discovers MF 550 that has the capabilities such as graphics and computing capabilities required to run the desired spatial computing functions.

MF 550 needs to be capable of interpreting or forwarding spatial computing configuration messages. At a minimum, the configuration messages may include identification of the spatial computing function to execute by MF 550, identification of the media or data streams to be processed (based on SDP mid attributes or equivalent identifiers), direction of the processing (uplink, downlink, or both) and function-specific parameters.

WTRU 510 correlates the spatial computing configuration parameters with the corresponding media lines advertised in the SDP. This is done using the a=mid: attribute in each media description. If the spatial computing function introduces new media streams (for example, a resulting video stream), IMS-AS 590 needs to insert the updated SDP lines in a re-INVITE procedure. Below is an example of an SDP offer that includes an audio stream, a video stream, and a data channel for spatial computing configuration.
v=0
o=−538051857716 2 IN IP4 203.0.113.1
s=SC Session
t=0 0
m=video 51372 RTP/AVP 101
c=IN IP4 192.114.1.1
a=rtpmap: 101 H 264/90000
a=mid: video0
m=application 5000 UDP/DTLS/SCTP webrtc-datachannel
c=IN IP4 192.114.1.1
a=mid: data0
a=sctp-port: 5000
a=dcmap:0 label=“processing-task”
a=sc-function:1 mid=video0 direction=downlink param=“frequency:20”

When the remote endpoint receives this offer, the remote endpoint responds with an SDP answer that either confirms or rejects the proposed spatial computing configuration attributes, in accordance with normal IMS session establishment rules. If the remote endpoint supports the data channel and the spatial computing functions, the remote endpoint responds with matching data channel parameters and indicates acceptance of the proposed spatial computing functions.

The present systems, method and devices may be utilized in ecosystems involving immersive or augmented or virtual reality (AR or VR) real-time communication services, including in 5G/6G telecommunication networks.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method of executing a spatial computing function in IP multimedia subsystem (IMS)-based augmented reality (AR) calls with data channel (DC) support, the method comprising:
performing spatial computing (SC) session setup and negotiation;
establishing an application session configured based on the performed SC setup and negotiation; and
running an invoked SC function.

2. The method of claim 1, wherein the performing SC session setup and negotiation comprises:
receiving an application DC request from a wireless transmit receive unit (WTRU);
creating a configuration at least including originating and terminating side DC media information;
configuring DC control instructions;
creating a spatial computing session request based on the created configuration and configured instructions;
allocating media resources based on the created spatial computing session request; and
establishing a session based on the allocated media resources.

3. The method of claim 2, wherein the receiving an application DC request from the WTRU is via the IP multimedia subsystem (IMS).

4. The method of claim 2, wherein the creating a configuration at least including originating and terminating side DC media information is via the DC signaling function (DCSF) of the IMS.

5. The method of claim 2, wherein the creating a spatial computing session request based on the created configuration and configured instructions is via the DCSF.

6. The method of claim 2, wherein allocating media resources based on the created spatial computing session request is via media function (MF) of the IMS.

7. The method of claim 1, wherein the establishing an application session configured based on the performed SC setup and negotiation comprises:
determining application source data;
exchanging configuration information; and
configuring SC function.

8. The method of claim 7, wherein the determining application source data is via the MF of the IMS and the WTRU.

9. The method of claim 7, wherein the exchanging configuration information is between the MF of the IMS and the WTRU.

10. A system for executing a spatial computing function in IP multimedia subsystem (IMS)-based augmented reality (AR) calls with data channel (DC) support, the system comprising:
an IMS, the IMS including:
an IMS application server (AS);
a DC signaling function (DCSF); and
a media function (MF) including a spatial computing (SC) function;
the IMS performing spatial computing (SC) session setup and negotiation;
the IMS establishing an application session configured based on the performed SC setup and negotiation; and
the IMS running an invoked SC function.

11. The system of claim 10, wherein the performing SC session setup and negotiation comprises:
the IMS receiving an application DC request from a wireless transmit receive unit (WTRU);
the IMS creating a configuration at least including originating and terminating side DC media information;
the IMS configuring DC control instructions;
the IMS creating a spatial computing session request based on the created configuration and configured instructions;
the IMS allocating media resources based on the created spatial computing session request; and
the IMS establishing a session based on the allocated media resources.

12. The system of claim 11, wherein the creating a configuration at least including originating and terminating side DC media information is via the DC signaling function (DCSF) of the IMS.

13. The system of claim 11, wherein the creating a spatial computing session request based on the created configuration and configured instructions is via the DCSF.

14. The system of claim 11, wherein allocating media resources based on the created spatial computing session request is via media function (MF) of the IMS.

15. The system of claim 10, wherein the establishing an application session configured based on the performed SC setup and negotiation comprises:
the IMS determining application source data;
the IMS exchanging configuration information; and
the IMS configuring SC function.

16. The system of claim 15, wherein the determining application source data is via the MF of the IMS and the WTRU.

17. The system of claim 15, wherein the exchanging configuration information is between the MF of the IMS and the WTRU.

18. The system of claim 10, further comprising the IMS running the SC function.

19. The system of claim 18, wherein the running the SC function occurs in the MF of the IMS.

20. The system of claim 19, wherein the MF further includes a SC function element for running the SC function.
